(19) United States
(12) Patent Application Publication
(10) Pub. No.: US 2001/0025590 A1
(43) Pub. Date: Oct. 4, 2001

(54) Safety system for road vehicles and a road vehicle with one such system

(76) Inventors: Richard Wall, Beverly Hills, CA (US); Kurt Seifman, New York, NY (US)

Correspondence Address: HOFFMAN WASSON & GITLER, 2361 JEFFERSON DAVIS HIGHWAY, SUITE 522, ARLINGTON, VA, 22202

(21) Appl. No.: 09/785,251

(22) Filed: Feb. 20, 2001

(30) Foreign Application Priority Data
Feb. 18, 2000 (DE) 200 02 985.1

(51) Int. Cl. E05G 1/00

(52) U.S. Cl. 109/23

(57) ABSTRACT

The Invention relates to a novel safety system for road vehicles and is characterized by a data safe which is housed in the motor vehicle with a receptacle for at least one data medium for personal data of the motor vehicle user.

The invention relates to a safety system as claimed in the preamble of claim 1 and to a road vehicle as claimed in the preamble of claim 9.

In the case of accidents, it is often vitally important that the emergency personnel receive information about the accident victim very promptly and reliably in order to be able to render effective assistance.

The object of the invention is to improve safety in motor vehicles in this respect. To achieve this object the motor vehicle is made according to claim 1.

The safety system as claimed in the invention for road vehicles enables prompt availability of life-saving data which are necessary for effective emergency aid. These data are for example the blood group, incompatibilities and allergies, special diseases, etc.

Developments of the invention are the subject matter of the dependent claims. The invention is detailed below using figures on embodiments.

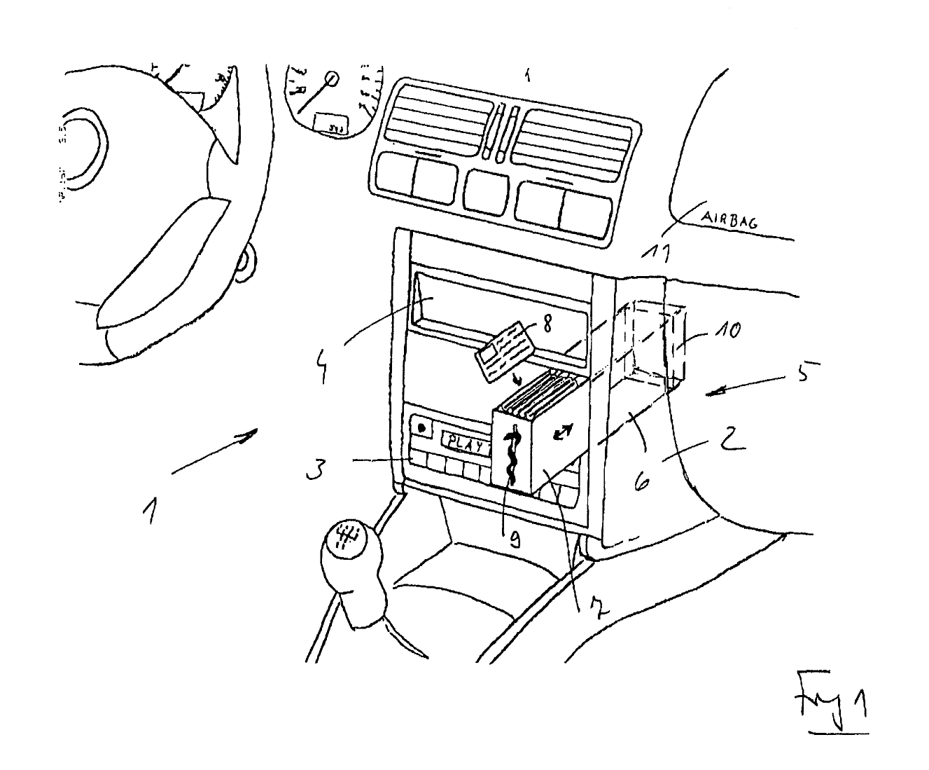

FIG. 1 shows in an enlarged partial view a motor vehicle passenger compartment together with a data safe housed in a middle console as claimed in the invention;

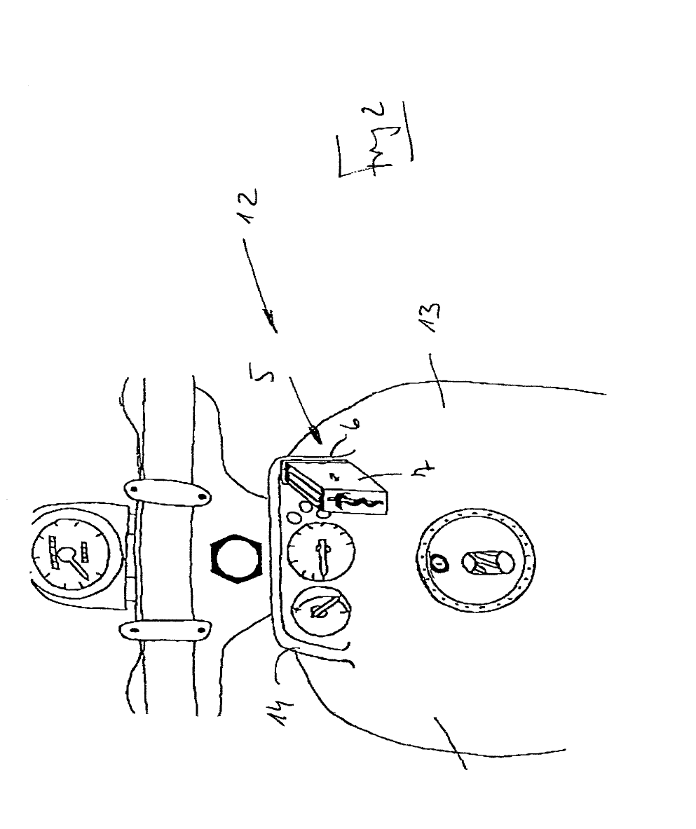

FIG. 2 shows in a partial view a motorcycle together with a data safe housed on the instrument panel,

FIG. 1 shows in an enlarged partial representation the passenger compartment of a passenger car generally labelled 1 with a middle console 2 on which conventionally different functional elements, such as a radio 3, ashtray 4, etc. are provided.

In the middle console 2 a data safe 5 is mounted which in the embodiment shown consists of a housing 6 and of a drawer-like receptacle 7 which can be closed by pushing it into the housing 6. The housing 6 and the receptacle 7 are made of a highly loadable, especially also a fireproof material, especially such that the safe 5 in the closed state, i.e. for the receptacle 7 pushed into the housing 6, can withstand high external forces and is also fire-resistant and heat-resistant so that data media 8 which are accommodated in the receptacle 7 are not destroyed even in a serious accident.

The data media 8, of which several can be accommodated in the receptacle 7, contain in addition to a picture (passport-sized photograph) also other life-saving data of the individuals normally using the passenger car, for example the blood group, incompatibilities, allergies, special diseases, etc.

The data are for example applied to the card-like data media 8 in written form and/or are filed to be machine-readable, for example in the form of a chip or a magnetic track or in another machine-readable form on the data media 8.

Normally the safe 5 is in the closed state and is kept in this state by a locking means provided on the housing 6. By unlocking which of course is accessible on the front side of the safe which is visible on the middle console 2 the safe can be opened. The safe 5 or the receptacle 7 is conspicuously identified at 9 on the front side of this receptacle so that in the case of an accident the safe 5 can be found quickly and opened by the rescue services

Within the housing 6 there is furthermore electronics 10 which is triggered for example by the initiating electronics of the airbag 11 and which in the case of an accident triggers an acoustic and/or optical signaller which is provided on the front of the housing 6, but is not shown, and which in an accident emits an optical and/or acoustic signal to make it easier to find the safe 5

The electronics 11 can also be made such that when activated it releases an inner lock for the receptacle 7 so that this receptacle 7 can be opened after manual unlocking of an external lock, with the advantage that in the normal case the safe 5 is closed and cannot be opened by unauthorized parties

Basically it is also possible to make the electronics 10 such that it is part of the Global Positioning Systems (GPS) and of a transmitter and in the case of an accident, i.e. when activated, it transmits a radio signal to be received by the rescue service which moreover also contains an exact indication of the position of the accident.

FIG. 2 shows in a partial representation a motorcycle 12 in which there is a data safe 5 in the area of the console 14 which is located on the motorcycle tank 13 for the controls and displays.

The invention was described above on embodiments. It goes without saying that numerous modifications are possible without departing from the inventive idea underlying the invention. Thus, for example, it is also possible to place the data safe 5 in other locations in the area of the vehicle. But preferably the data safe is provided where according to experience in case of accident the least damage on a motor vehicle can be expected. The data safe 5 can be planned in the production of the motor vehicle in the frame or in the body of this motor vehicle at a suitable location and can be provided permanently.

But basically it is also possible to retrofit existing motor vehicles with the data safe 5.

It was assumed above that activation of the electronics 10 takes place by the initiating mechanism of the airbag 11. But instead or in addition, it is also possible to provide an additional sensor on the motor vehicle, for example also on or in the housing 6, for the triggering of the electronics 10; this sensor responds at an acceleration exceeding what is conventional in any axial direction and in this way activates the electronics 10.

### Reference number list

1.passenger compartment

2. middle console

3. radio

4. ashtray

5. data safe

6. housing

7. receptacle

8. data medium

9. front of the safe

10. electronics

11. airbag

12. motorcycle

13. tank

14. console

1. Safety system for road vehicles, characterized by a data safe (5) which is housed in the motor vehicle (1, 12) with a receptacle (7) for at least one data medium (8) for personal data of the motor vehicle user.

2. Safety system as claimed in claim 1, wherein the data safe (5) and/or its receptacle (7) and/or a housing (6) of this safe are made highly loadable and/or fire-resistant and heat-resistant.

3. Safety system as claimed in claim 1 or 2, wherein the data safe (5) is identified on its front which is intended for opening, preferably also optically identified.

4. Safety system as claimed in one of the preceding claims, characterized by electronics (10) which in the case of an accident triggers at least one optical and/or acoustic indication means for finding the data safe.

5. Safety system as claimed in one of the preceding claims, wherein at least one data medium has the form of a card, for example a machine-readable card.

6. Safety system as claimed in one of the preceding claims, wherein the electronics (10) is made as a transmitter for emitting an assistance signal, preferably together with a position-finding signal.

7. Safety system as claimed in one of the preceding claims, wherein the data safe (5) is attached in the area of the motor vehicle middle, for example in the area of the middle console (2) or of the motor vehicle tunnel.

8. Safety system as claimed in one of the preceding claims, wherein the motor vehicle is made as a motorcycle the data safe is housed in the frame and/or in the area of the handlebars and/or the area of a console which is provided directly behind the middle of the handlebars.

9. Road vehicle, characterized by its being equipped with a safety system as claimed in one of claims 1-8.
